(19) United States
(12) Patent Application Publication
(10) Pub. No.: US 2005/0228684 A1
(43) Pub. Date: Oct. 13, 2005

(54) Integrated computerized system and method for management of intellectual property

(76) Inventors: Pavel Pogodin, San Mateo, CA (US); Joseph Bach, Morgan Hill, CA (US)

Correspondence Address: TRANSPACIFIC LAW GROUP, 617 NORTH DELAWARE STREET, SAN MATEO, CA, 94401, US

(21) Appl. No.: 10/824,020

(22) Filed: Apr. 13, 2004

(51) Int. Cl. G06F 17/60; G06F 15/00

(52) U.S. Cl. 705/1; 715/500

(57) ABSTRACT

An integrated computerized method for submission, review, and disposition of inventions. The entire submission, review and disposition are performed electronically and there's no need to a face-to-face meeting for reviewing of the submitted invention. The disposition is performed electronically and may include automatic assembly and transmission of engagement letter, automatic assembly of provisional application, and automatic assembly and upload of a defensive publication.

### BACKGROUND OF THE INVENTION

1. Field of the Invention

The present invention relates to computerized method for management of intellectual property. More specifically, the present invention provides a computerized method for submission, review, and disposition of new inventions.

2. Description of the Related Art

Generally, many companies have a certain process for employees' submission of new invention, and for review and disposition of the submitted inventions. Conventionally, an employee having a new invention needs to fill out a certain form and submit the form to the legal department for review. An intellectual property attorney, sometimes with the assistance of representative from engineering and/or marketing department, review the submitted form and makes a decision as to the disposition of the submitted invention. Once a decision is made to file a patent application to cover the invention, a letter is sent to an outside attorney requesting the attorney to draft a patent application.

There are several drawbacks to the conventional method. For example, since the review normally requires a meeting of several people, such a review meeting is not scheduled until a number of invention forms were submitted for several inventions. Depending on the company, this may be a week, a month, or even more. Thus, a submitted invention may not be reviewed for a long time. Similarly, the review requires the coordination of schedules of several people to find a time convenient for the meeting for all of the reviewers. This may further delay review of inventions. Also, if during the review the reviewers decide that they need more information in order to make a decision, they need to ask the inventor for the information and re-review the case in the next meeting, which further delay review.

### SUMMARY OF THE INVENTION

The present invention solves the deficiencies of the conventional method by providing an integrated computerized method for submission, review, and disposition of inventions. In various aspects of the invention, the entire submission, review and disposition are performed electronically and there's no need to a face-to-face meeting for reviewing of the submitted invention. In other aspects of the invention, the disposition is performed electronically and may include automatic assembly and transmission of engagement letter, automatic assembly of provisional application, and automatic assembly and upload of a defensive publication.

According to one aspect of the invention, a computerized system is provided which enables employees to electronically submit invention alerts for new inventions. Each such submission is electronically docketed in a database, receives an electronic date stamp, and receives a tracking number. A notice is then sent to the patent review committee, which may include an in-house attorney, an engineering representative, a marketing representative, etc. Each person may then rate the importance of the invention, and the rating is transmitted to the final decision maker, e.g., the in-house attorney. The final decision maker may then decide on a final disposition, which is then transmitted to, and recorded in, the database. A notice of the final disposition may also be sent to the invention.

If the final decision is to abandon the case, no further action is required. If the final decision is to obtain a prior art search, the final decision maker may select a searcher from a database and then an engagement letter with attachments, such as an invention alert form, is automatically generated and electronically sent to the searcher. If the decision is to file a provisional application, a provisional application is automatically generated and electronically sent to the inventor for review. After the inventor's review, the generated provisional application may be printed and filed. If the decision was to publish the invention as a defensive publication, i.e., to generate a bar to prevent others from obtaining a patent on the invention, a publication document is automatically assembled and sent to the invention for review. After the inventor's review and approval, the generated publication may be automatically uploaded to an online defensive publication service. If the final decision is to file a conventional patent application, the final decision maker may select an outside counsel from a database and then an engagement letter with attachments, such as an invention alert form, is automatically generated and electronically sent to the outside counsel.

According to further aspects of the invention, if one of the reviewers, or the in-house attorney, need more information from the inventor, a request is electronically sent to the inventor. The inventor may then add additional description or attach more files to the original submission, however the newly added material receives a new electronic date stamp. The newly added material is then made available to the reviewers.

### BRIEF DESCRIPTION OF THE DRAWINGS

Other aspects and advantages of the invention may become apparent from the detailed description of the invention, in which various embodiments are descried with reference to the drawings in which:

FIG. 1 is a general flow diagram of an embodiment of the invention.

FIG. 2 is a general schematic of a computerized system according to an embodiment of the invention.

FIG. 3 depicts an example of an electronic invention submission form according to an embodiment of the invention.

FIG. 4 depicts an example of an electronic rating form according to an embodiment of the invention.

FIG. 5 depicts an example of an electronic disposition form according to an embodiment of the invention.

### DETAILED DESCRIPTION

The present invention will be described with reference to various embodiments thereof, which are provided in order to illustrate various aspects of the invention, but which may not be understood to limit the invention as defined by the appended claims.

Various aspects of the invention are implemented in the form of a computer program to control a general-purpose computer to execute the various functions and steps of the inventive system and method. The program may be in any form, such as, for example, and HTML, XML, Java, etc.

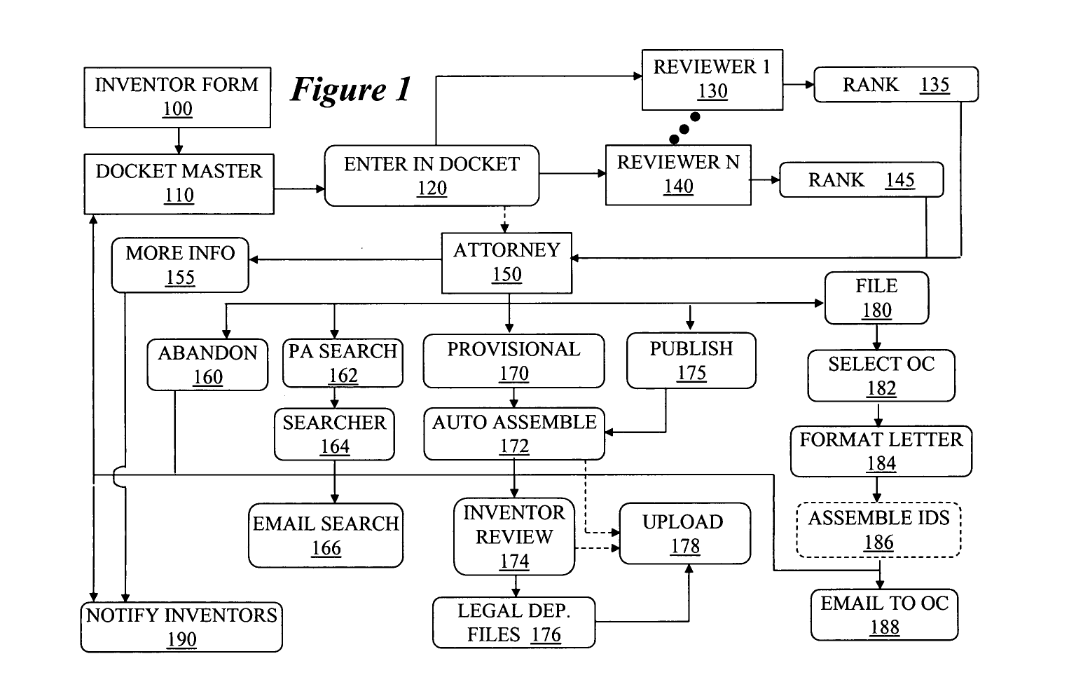

FIG. 1 is a flow chart depicting the various features of an embodiment of the invention. More specifically, in step 100 an inventor login to the system and is provided with an electronic invention disclosure form. The form incorporates various fields, which the inventor is requested to fill out. The fields may be, for example, “Title;” “Inventor(s) name(s);” “known prior art;” “advantages of the invention;” “description of the invention;” etc. The inventor may also be provided with the option to attach other electronic documents, such as MSWord documents, Power Point presentations, etc. Once the inventor completed filling out the form, the inventor may electronically submit the form to the database.

According to one specific feature of the invention, the inventor must print the completed form before he can electronically submit it. That is, it may be desirable for the legal department to obtain an originally signed invention disclosure in a paper form. To encourage the execution of the form, when the inventor completes all the entries in the electronic form, a message appears which requests the inventor to print the form, sign it, and send it to the legal department. With that message a “print” icon is provided so that the inventor may click on it to print the form. Only if the print icon is clicked, the system provides a “submit” icon. Consequently, the inventor cannot skip the printing step and only submit the invention electronically. Since the inventor is made to print the form, it is more likely that the inventor will actually sign it and send it to the legal department. Otherwise, it is likely that the inventor will file the form electronically and fail to follow up with a signed paper form.

Once the inventor submits the form, it may electronically be sent to the docket master 110 via, for example, an email. That is, according to this embodiment, access to the system is controlled according to functions such as user and administrator. For example, the docket master has full access to the system both as a user and as an administrator. Thus, the administrator can access any area of the system and make changes and amendments. For example, the administrator is able to add to the database new outside attorneys, new searchers, and able to provide and control access to the system to other personnel. On the other hand, other personnel may have access only as a user, such as inventors. Inventors may only submit new invention alerts and information relating to inventions, but can't modify anything in the databases. Yet others may have mixed access rights. For example, in-house attorneys may have full user rights, but limited administrator rights, so they may be able to add new outside attorney and searchers, for example.

When the new invention form is submitted to the docket master, it is entered in the docket database at step 120, and receives a docket number and a date stamp. Then, the system automatically sends emails to the designated reviewers 130, 140, indicating that a new invention was submitted, which requires their review and rating. This can be done by, for example, including in the email a URL link to the invention form in the database. Optionally, a similar message is also sent to the in-house attorney, 150. The reviewers then rank the invention, 135, 145, and the ranking is being forwarded to the in-house attorney 150. Additionally, the system averages the ranking and provides the in-house attorney an average ranking.

A feature of the embodiment depicted in FIG. 1 is that either reviewer or the in-house attorney may request the inventor for additional information, 155, before a decision may be made. That is, when the reviewer or in-house attorney clicks the link on the email and gets to the invention form, an icon is provided on the form labeled, e.g., “request additional information.” When the icon is clicked, an email is generated and sent to the inventor asking him to add information and providing a link to a location on the database for adding more information. The inventor may then type in additional information and/or attach more documents. When the inventor adds new information, the new information is tagged with an electronic date stamp. As can be appreciated, the new date stamp will be different from the original date stamp of the original form submission, so that the integrity of the original submission is maintained. Further, once a new information is added, an email is being generated and sent to the requestor indicating hat the information has been provided and a link is available to the information on the database.

Once all of the information and rating has been provided, the in-house attorney may take either of several actions: abandon the case, 160, request a prior art search, 162, file a provisional patent application, 170, publish a defensive publication, 175, or file a conventional patent application, 180. As can be seen in FIG. 1, when either of the action is taken, a note is sent to the docket master 110 and inventor 190. The actions may be taken by simply selecting one of these actions from a drop down menu on the invention form. Thus, when the action is taken, it is automatically recorded in the database.

When a decision has been made to abandon the case, 160, a notification is generated, but no other action is being generated. If a decision has been made to request a prior art search, 162, a drop down menu is provided having a list of searchers the firm has business relationship with. The in-house attorney may then select a specific searching firm, 164, from the drop down menu. When a searching firm is selected, the system automatically assembles an engagement letter and sends the letter electronically to the firm, 166, with the invention form as an attachment. Alternatively, rather than sending the form as an attachment, a link to the database may be provided.

If a decision has been made to file a provisional patent application, the system automatically assembles a disclosure and the forms required for filing a provisional patent application. That is, using the entries provided by the inventor, the system automatically assembles a disclosure and uses the entries to fill out the provisional patent application submission form and fee transmittal form. A notice is then automatically generated and sent to the inventor, 174, with a link to the database to review the disclosure as assembled by the system. The inventor is then able to approve or amend the disclosure. Once this is done, the legal department is notified, so that the assembled application may be printed and filed 176.

If a decision has been made to publish the submitted invention in a defensive publication, the system automatically assembles a publication document using the data entered by the inventor, 172. The assembled document is then sent to the inventor for review, amendment, and approval, 174. Once the document is approved, the legal department is notified, 176, and may then upload the document to a defensive publication web site, 178. Such a web site is available at, for example, www.IPFREEDOM.com. The document is then made available to the public and is searchable by the public. Alternatively, the publication upload may be done automatically once the document is assembled, or by the inventor after review and approval of the document.

If a decision has been made to file a conventional patent application, 180, the in-house attorney may select an outside counsel from a drop down menu, 182. When an outside counsel has been selected, the system generates an engagement letter, 184, and sends the letter via email to the outside attorney, including a link to the invention form, or the invention form as an attachment. Optionally, using the data entered by the inventor, such as keywords and known prior art, the system searches a prior art database and assembles an Information Disclosure Statement with a form 1449 for submission with the patent application.

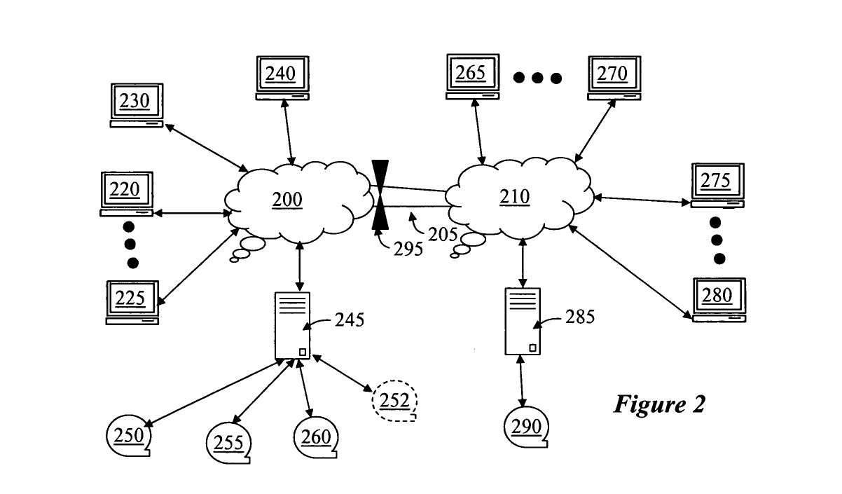

FIG. 2 is a general schematic of a distributed computerized system according to an embodiment of the invention. In this embodiment, an intranet network 200 is provided with restricted access to users, e.g., only users within a certain organization, such as a certain company owning the intranet. The intranet 200 is connected to the internet 210 via a conventional connection line, such as a T1, ISDN or DSL line, optionally through a firewall 295, as is well known in the art. Consequently, as can be appreciated, elements in FIG. 2 having an arrow to the intranet 200 have direct access to the intranet 200 and internet 210. On the other hand, elements having arrow to the internet 210 have direct access to the internet 210 but, unless provisions are made, no access to the intranet 200. That is, as is known in the art, a traveling user having intranet access privileges may gain access to the intranet 200 via the internet 210 using a password or other security means, such as VPN well known to persons of skill in the art.

The majority of the IP management program for executing the method of the inventive concept generally resides on server 245, connected to the intranet 200. The server 245 comprises, or have access to, administration database 250, alerts database 255, suppliers database 260, and, optionally, prior art database 252. On the other hand, the defensive publication program resides on server 285, connected to the internet 210 and comprising, or having access to, defensive publication database 290. As can be understood, the information on database 290 can be accessed and viewed freely by anyone having public access to the internet 210. The defensive publications residing in database 290 can be made available via HTTP protocol by providing the server 285 with the web server software that receives requests via HTTP and generates dynamic web pages using the defensive publication data stored in the database 290. The generated web pages containing the defensive publication data are returned by the server 285 to the requestor. In another embodiment, the information in the defensive publication database 290 can be made available to users via FTP protocol. The prior art database 252 may include copies of the disclosures of patent documents with all other information, such as patent numbers and claims removed. This database may be available to the users of the intranet 200 or, in one embodiment, the Internet.

The databases 250, 255, 260, 252 and 290 can be any database systems either of relational type or otherwise. One such database is MySQL freely available from MySQL AB (www.mysql.com). Commercial vendors such as Oracle, Microsoft and IBM sell numerous other suitable database products. For security of the invention information, all or some records in the alerts database 255 and/or administration database 250 may be encrypted using any known encryption technology. The access to those and other aforementioned databases may be also restricted to predetermined set of users using access passwords. The aforementioned servers 245 and 285 can be of any known type. In one embodiment of the invention, the servers are implemented using generic Intel-based computer hardware, or clusters thereof, such as that available from Dell Inc. The aforementioned servers can utilize any available server software such as Apache HTTP Server, iPlanet Server, of Microsoft Server software, which are well known to persons of skill in the art. It should be also noted that databases 250, 255, 260, 252 as well as 290 need not reside on a single physical server. The above databases can be of a distributed type residing on clusters or grids composed of multiple physical servers.

In an embodiment of the inventive technique, when the decision is made to disclose the invention as a defensive publication, the inventor may be notified via an e-mail alert. The e-mail message to the inventor may contain a URL link to the web form requesting from the inventor additional disclosure, text approval or other information necessary to complete the defensive publication. This web form may reside on the server 245 and be provided over to the inventor via HTTP using the aforementioned web server software. Once the inventor supplied the requisite additional information and/or approval, the IP management program residing on the server 245 updates the databases 250 and/or 255 and communicates the defensive publication information to the publication server 285. The communication may be by way of HTTP or FTP protocol communication request or by way of an e-mail exchange. Alternatively, the publication data may be shipped by non-electronic means, such as by copying the defensive publications on a CD-ROM and mailing the envelope. The contents of the CD-ROM are then manually copied by the operator to the server 285. Additionally, server 245 may accumulate several defensive publications and ship them at once as a batch.

During the transmission, the defensive publication information may be also encrypted and/or compressed. The software running on the server 285 receives the defensive publication information and uses it to create at least one entry in the defensive publication database 290. Optionally, the server 245 may be programmed to allow the inventor to complete the defensive publication only within a predetermined amount of time.

In another embodiment of the inventive technique, the aforementioned web form requesting additional details from the inventor may reside on the server 285 and be provided over to the inventor via HTTP using the aforementioned web server software. To this end, after the decision to publish defensively is made, the IP management software on server 245 sends a notification and/or data to the defensive publication server 285. This notification may be sent via HTTP, FTP or e-mail protocols. Once the inventor supplied the requisite additional information, the software running on server 285 uses this information to create or modify at least one entry in the defensive publication database 290.

Subsequently, the defensive publication based on the information supplied by the inventor and received from the IP management software on server 245 is included into a publication catalog/index residing in the database 290 and is made available to the public by means of server 285. This server may enable the public to access the “published” defensive publications via HTTP, FTP, fax or e-mail protocols. It should be noted that the described system may solicit the additional information required to complete the publication not from the inventor, but form a technical writer or any other person.

In yet another embodiment, the defensive publication is transmitted from the server 245 to server 285 and published by server 285 over the web without intervention by the inventor. In yet another embodiment, all invention disclosures received by the IP management system are published defensively. Finally, the server 285 may return a conformation to server 245 confirming that the invention was successfully published. Optionally, the server 285 may also return the timestamp of the publication as well as the digital signature thereof, such as the widely used MD5 fingerprint. Said returned information may be put into the databases 250 and 255.

Terminals 220-225 are any number (indicated by the three dots) of organization-user computers, such as general-purpose personal computers, having connection to the intranet 200. As eluded to above, any number of these terminals may access the intranet 200 via internet 210 using a special access key or password. Terminals 265-270 are any number (indicated by the three dots) of public-user computers, such as general-purpose personal computers, having public access to the internet 210. Terminals 275-280 are any number (indicated by the three dots) of supplier-user computers, such as general-purpose personal computers, having public access to the internet 210.

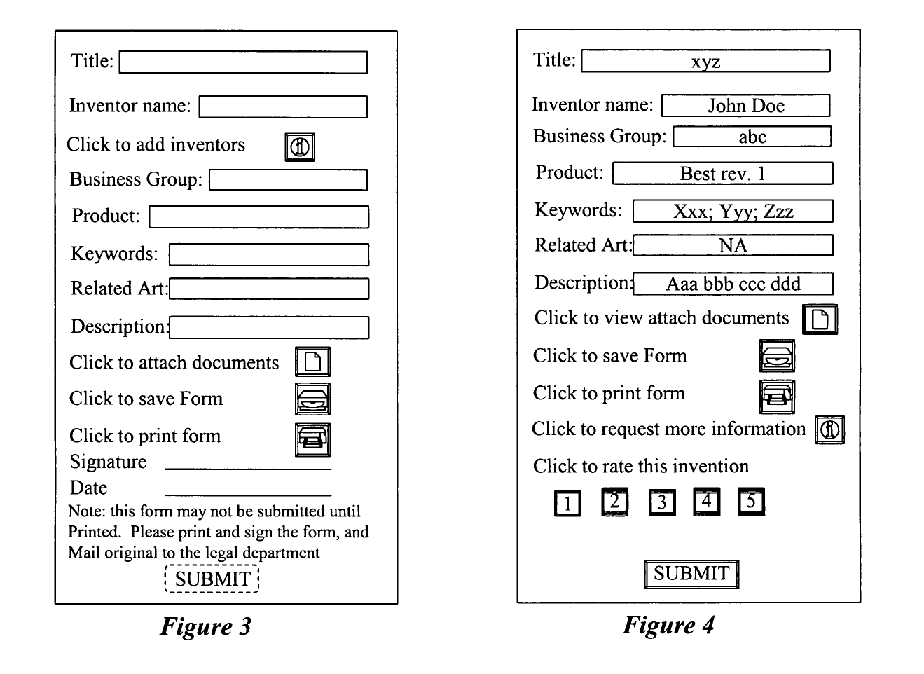

The various features of the embodiment of FIG. 2 will now be described using illustrative example. When a person belonging to the organization has a new idea that he would like to patent, the person logs on to one of organization-user terminals, say terminal 220, and logs on to the IP management program residing on server 245. The user is then provided with an electronics invention submission form for data entry. FIG. 3 depicts an example of an electronic invention submission form according to an embodiment of the invention. As depicted in FIG. 3, the electronic form includes fields for entry of a title, inventors' name, business group, product, keywords, related art, and description of the invention. The fields may be expandable to accommodate restricted or unrestricted number of input characters. Other fields that may be provided include date of conception, date of first testing, date product would be shipped or sold, date of potential disclosure to third parties, etc.

The form also includes an icon enabling the user to attach documents to the form. These may be electronic documents in any format and, when attached, are uploaded from the user's terminal to the server 245 and stored together with the form in alerts database 245. A save icon is provided to enable the user to store the form on the user's terminal 220, and a print icon is provided to enable the user to print the form. As shown in FIG. 3, the form includes two fields that cannot be entered electronically; namely, signature and date. According to a feature of this embodiment, a “submit” icon is provided in an inactive form (as exemplified by the dashed lines); and becomes active only after the user prints the completed form. Consequently, the user must print the form before submitting it electronically. This is done to encourage inventors to print and actually sign and date the form, so that the internal legal department of the organization may have an originally signed document evidencing the submission—in addition to the electronic form. OF course, this feature is optional and the submit icon can be provided in active form at any time.

Once the submit icon is clicked, the completed form, including any attached documents, are provided with an electronic date stamp and a serial number, and are stored in alert database 255. According to a feature of this embodiment, once the form is submitted, the system interrogates administration database 250 to see which reviewers and in-house attorneys are associated with the business group entered on the form. The system then fetches the email address of the corresponding reviewers and in-house attorneys and emails to them a notification that a new form has been submitted, including a link to the location on database 255 where the submitted form is stored. When a reviewer 230, and optionally in-house attorney 240, clicks on the link, the electronic rating form illustrated in FIG. 4 is provided. The reviewer may review the data entered and the attached documents and make a judgment as to the importance of patenting the submitted invention, by rating the invention using the numbered icons. Alternatively, the rating may be a binary file/don't file rating.

According to a feature of this embodiment, when the reviewer cannot make a decision based on the information provided, the reviewer may click on an icon to request more information. When this icon is clicked, an email is automatically sent to the person who originally submitted the form, requesting the inventor to add more information. The inventor is then provided with a form to enter more information and/or attach more documents. When the additional data is entered and submitted, it automatically receives a new electronic date stamp, so that the date of the submission of the additional information can be distinguished from the original submission. Also, the requesting reviewer is notified by email that additional data has been entered.

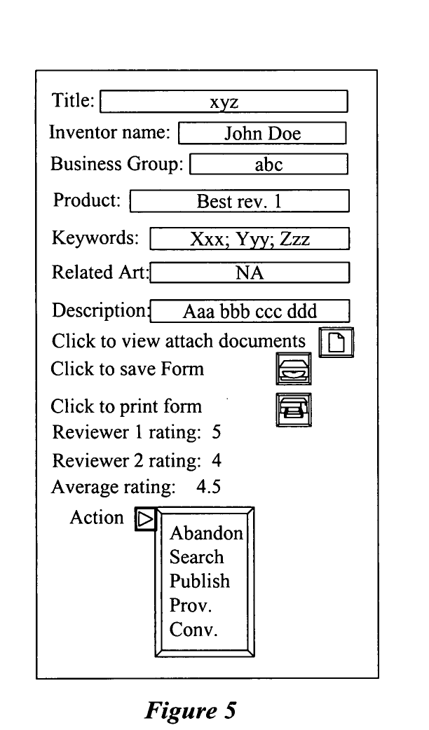

Once all of the reviewers rate the invention, a final decision maker, e.g., the in-house attorney, receives an email with a link to a disposition form which includes all of the ratings and an average rating. FIG. 5 depicts an example of such disposition form. The form also includes provisions, e.g., a drop-down menu, for the decision maker to act on the case. For example, the case may be abandoned, a prior art search may be ordered, the case may be published as a defensive publication, the case may be filed provisionally, or the case may be filed as a conventional patent application. Other options may be provide such as, for example, file a design patent, file a utility model (non-U.S.), etc.

Finally, the administrative database 250 and/or the alerts database 255 may contain records tracking incentive payments to inventors for submitting invention disclosures. These records may be automatically created and/or updated upon submission of a new disclosure, as well as filing or publication decision. The system may also be linked with financial database, which may comprise means for making automatic payments to inventors.

While the invention has been described with reference to specific embodiments thereof, it would be appreciated by those of ordinary skill in the art that the invention is not limited to these embodiments, and that various modifications can be made without departing from the scope and spirit of the invention, as can be gathered from the specification and claims appended thereto.

1. A computerized method executable by a general purpose computer, programmed to perform the steps comprising:
providing a user with an electronic invention disclosure form having data fields for data entry by the user;
receiving the data entries from the user and, once the user has submitted a completed form, issuing a date stamp for the completed form;
sending an electronic notice to at least one pre-defined invention reviewer, and enabling the reviewer to associate a grade to the form;
enabling a pre-designated decision maker to select one action from the group comprising “abandon” and “file”.

2. The method of claim 1, wherein said grade comprises a binary file/don't file grading.

3. The method of claim 1, wherein said group further comprises “publish” and “provisional”.

4. The method of claim 1, wherein when said decision maker selects “file”, the system automatically generates an engagement letter and send the engagement letter via email to a designated counsel, together with the completed invention disclosure form and any attachments.

5. The method of claim 3, wherein when said decision maker selects “publish”, the system automatically generates a defensive publication and uploads the publication to a designated website.

6. The method of claim 3, wherein when said decision maker selects “provisional”, the system automatically generates a provisional application.

7. The method of claim 1, further comprising enabling the reviewer to request further information and wherein when said reviewer request further information, the system automatically emails a request to the user and enables the user to add new data to form, and wherein the system issues a new electronic date stamp to the new data.

8. The method of claim 4, wherein said form query the user to input keywords, and wherein when said decision maker selects “file”, the system automatically searches a prior art database using said keywords and generates a list of related art from said database.

9. A computerized system executable by a general purpose computer, comprising:
a central computer executing a main program;
an invention disclosure database;
a counsel database; and,
a reviewer database;
wherein said main program is structured to perform the steps comprising:
providing a user with an electronic invention disclosure form having data fields for data entry by the user;
receiving the data entries from the user and, once the user has submitted a completed form, issuing a date stamp for the completed form and storing the completed form in said inventions disclosure database;
sending an electronic notice to at least one pre-defined invention reviewer listed in said reviewer database;
wherein when said main program receives an input to file a patent application on a selected completed form, the system automatically generates an engagement letter and send the engagement letter via email to a designated counsel from said counsel database, together with the completed invention disclosure form and any attachments.

10. The computerized system of claim 9, further comprising an upload mechanism, wherein when said main program receives an input to publish said completed form, said main program compiles a disclosure document and said upload section uploads said disclosure document to a publicly accessible website.

11. The computerized system of claim 9, further comprising a prior art database and, when said main program receives an input to file a patent application on a selected completed form, the system automatically searches said prior art database and generates a prior art list.
